(19) United States
(12) Patent Application Publication
(10) Pub. No.: US 2017/0327384 A1
(43) Pub. Date: Nov. 16, 2017

(54) REMOVAL OF IMPURITIES FROM BRINE

(71) Applicant: PreProcess, Inc., San Ramon, CA (US)

(72) Inventors: Marc Privitera, San Ramon, CA (US); Christina Borgese, San Ramon, CA (US)

(21) Appl. No.: 15/595,833

(22) Filed: May 15, 2017

Related U.S. Application Data
(60) Provisional application No. 62/335,953, filed on May 13, 2016.

(51) Int. Cl. C01D 15/00; C22B 3/12; B01D 21/26; C22B 3/08; C22B 26/12; C22B 3/22

(52) U.S. Cl. CPC C01D 15/00; C22B 26/12; C22B 3/22; B01D 21/262; C22B 3/08; C22B 3/12; C01P 2006/80

(57) ABSTRACT

Apparatuses and methods for extracting desired chemical species and/or impurities from input material. An aspect of the present disclosure comprises a continuous flow system using solvents and other reactants to assist in conversion and extraction of the desired output material and/or removal of specific impurities from the input material through pressure, temperature, and volume control within the extraction system.

### CROSS-REFERENCE TO RELATED APPLICATIONS

This application claims the benefit under 35 U.S.C. §119(e) of U.S. Provisional Application No. 62/335,953, filed May 13, 2016 and entitled “REMOVAL OF IMPURITIES FROM BRINE,” which application is incorporated by reference in its entirety.

### FIELD

Aspects of the present disclosure generally relate to purification of materials, and more particularly to removal of impurities from brine solutions.

### BACKGROUND

Reference may be made herein to other United States Patents, foreign patents, and/or other technical references. Any reference made herein to other documents is an express incorporation by reference of the document so named in its entirety.

Recent advances in chemical processes allow for separation of species from raw materials. An element of interest is Lithium (Li), as lithium compounds are employed in various applications. For example, lithium stearate (C₁₈H₃₅LiO₂) may be used in lubricants, lithium hydroxide (LiOH) is used in breathing gas purification systems for spacecraft, submarines, and rebreathers to remove carbon dioxide from exhaled gas, and lithium metal can be alloyed with other metals, e.g., aluminum, copper, manganese, and cadmium to make high performance alloys for aircraft and other applications. Lithium metal also has the highest specific heat of any solid element, so lithium may be used in heat transfer applications. Lithium is also used as an anode material in rechargeable batteries for various devices.

Extraction, purification, and/or separation of lithium as a metal, or as a species, from raw material is often difficult and expensive.

### SUMMARY

The present disclosure describes methods and apparatuses for separation and/or purification of lithium and/or lithium species from raw materials.

The above summary has outlined, rather broadly, some features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same or similar purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a process flow diagram for species separation in an aspect of the present disclosure.

FIG. 2 illustrates a process flow in an aspect of the present disclosure.

FIG. 3 illustrates an example of an analyzer in accordance with an aspect of the present disclosure.

FIG. 4 illustrates the dissolution process in accordance with an aspect of the present disclosure.

FIG. 5 illustrates an apparatus in accordance in accordance with an aspect of the present disclosure.

FIG. 6 illustrates a slurry analyzer in accordance with an aspect of the present disclosure.

FIG. 7 illustrates a process flow diagram illustrating a method for producing oils in accordance with an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

### Overview

Other approaches have been undertaken to extract lithium, specific lithium species, and/or other chemical compounds from raw materials. The raw materials are directly exposed to solvents, such as acids, and the lithium metal and/or lithium species are dissolved and/or extracted. With such approaches, however, subsequent batch processing is required, and the problems of limited solid-to-solid reaction surface area make such related approaches time consuming and/or costly.

A material containing lithium may be in one or more forms, e.g., liquid, particle, fiber, gas or block, and may have additional constituents included in the material. The material may be processed, through one or more operations, to remove and/or purify the lithium or other species desired.

In some processes, the raw material is processed with an oxidizer, oxide, carbonate, and/or other gas, liquid, or solid to selectively remove various impurities. Because lithium is very reactive, lithium is often processed in a brine solution. Further, lithium almost always occurs in an ionic compound material. To purify and extract the lithium from such substances, various chemical processes are undertaken to remove the impurities in the raw material. The materials are used in combination with each other and in combination with a process which specifies certain parameters to effect the removal of the impurities.

Each of the purification materials may be employed in various proportions to remove a specific impurity and/or impurities from the material. For example, a combination of hydroxides and carbonates with air oxidation may remove silica and iron from brines to allow the isolation and extraction of lithium, potassium and sodium from the solution.

Lithium often occurs in materials and/or compounds that also contain other metals, such as aluminum and iron, as well as other materials such as silica. To process brine containing a mixture of lithium, iron, aluminum and silica, the brine is heated and an air flow across the surface of the brine (or bubbled through the brine) is employed to oxidize the iron and precipitate the iron from the brine. The air flow also co-precipitates the silica and aluminum from the brine solution through oxidation.

However, air flow oxidation is a slow process. Further, air flow cools the brine, which decreases the rate of precipitation of the iron, aluminum, and silica impurities, because the air has a heat capacity an order of magnitude lower than the brine. To expedite the precipitation process, chlorine and/or peroxide precursors, either as liquids or gases, are added to the air flow.

Addition of chlorine and/or peroxides may cause undesired conditions, as the increased concentrations of chlorine and/or oxygen create by-products that are hazardous, flammable, and/or create unsafe operating conditions for the lithium purification/extraction. Further, such by-products must also now be processed, increasing the overall cost of the lithium production/extraction/purification process.

In an aspect of the present disclosure, the air oxidation process may be assisted by adding hypochlorites to the combination of materials. In another aspect of the present disclosure, the process parameters of the lithium extraction/purification may be better controlled to more effectively remove the impurities. By controlling such process parameters such as pH, temperature, pressure, and shear rates, and/or selectively combining these controls with the hydroxide, air, hypochlorite and carbonate materials, may increase the efficiency of the impurity removal.

In an aspect of the present disclosure, the raw materials are sheared such that the surface area of the raw materials is increased with respect to the reactants. In another aspect of the present disclosure, temperature and/or pressure are controlled to allow for different portions of the process to produce different solubilities of lithium metal and/or lithium species within the slurry of raw material and/or solvent(s), such that different species may be selectively removed and/or separated from the process as desired. Such lithium species comprise lithium chloride, lithium hydroxide, carbonate, sulfate, nitrate, and other lithium species without departing from the scope of the present disclosure.

Although described with respect to lithium and/or lithium species, other elements and/or species, e.g., calcium and/or other alkaline earth metals, sodium and/or other alkali metals, etc., and/or other impurity removal may be employed without departing from the scope of the present disclosure.

### Process Flow

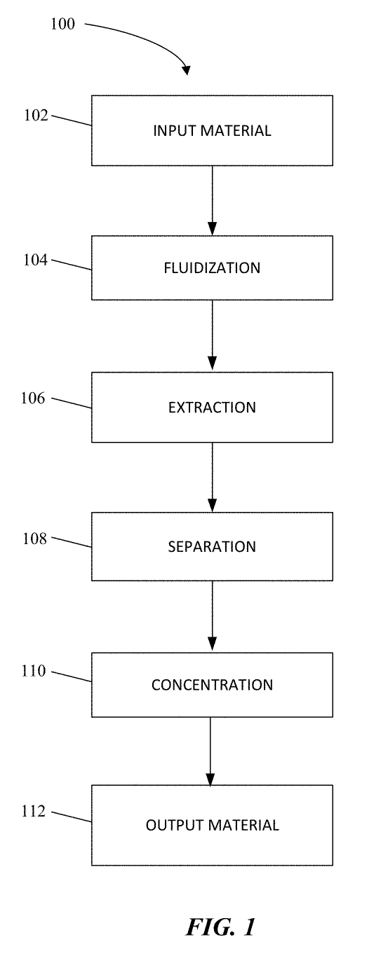

FIG. 1 is a process flow diagram for producing desired species (which may include alkali metals, alkaline earth metals, rare earth elements such as the lanthanide series, and/or species thereof) in an aspect of the present disclosure.

Process 100 starts with an input material 102. The input material 102 may then subjected to a fluidization process 104. The liquefied material may then be dissolved or otherwise solubilized and/or fluidized in an extraction process 106, and the fluidized input material may then be placed in a separation process 108. The separated material may then be placed in a concentration process 110. The concentration process 110 produces an output material 112.

In an aspect of the present disclosure, process 100 begins with an input material 102 comprising lithium ore, raw material comprising lithium, or other materials. The input material 102 may be referred to as “raw material” or a “feedstock” where large quantities of input material 102 are present. The present disclosure, in an aspect, may employ other input material 102 that contain catalysts which may aid in removal of the desired metals and/or species from the feedstock. Further, input material 102 may comprise material that includes additives that may combine with some portion or other by-products of input material 102 to produce desired species and/or metals in the output material 112.

Depending on the type of the input material 102 that is used in process 100, the input material 102 may be liquefied and/or homogenized to allow further processing of the input material in later stages of the process 100. For example, if the input material 102 is in solid or semi-solid form, the fluidization process 104 may convert the solid or semi-solid input material 102 into a form that will be more efficiently fluidized and/or liquefied in the extraction process 106 or in later portions of process 100. If the input material 102 is not of a homogeneous nature, the fluidization process 104 may also homogenize the input material 102, such that the fluidization process has a more uniform effect on the input material 102.

A material in the form of a slurry, liquid, particle, fiber, or block of input material 102 comprising constituents occurring naturally in various alkali metal/alkaline earth metal containing materials may be separated from, and/or impurities may be removed from the input material 102 in a series of operations. As described with respect to processes 100 and/or 200, separation and/or purification of certain desired species, metals, or other desired output materials 112 from various other constituents found in the input material 102 may be achieved in an aspect of the present disclosure. The output material 112 created through the process described may also create a feedstock for further isolation and purification operations to present market-ready products and/or products useful for adding to market-ready products.

The input material 102 may be a fluidized solid stream, i.e., a slurry of solid in a gas, a slurry, i.e., a solid intermixed with a liquid carrier, or loose solids that are capable of moving through processes 100 and/or 200. Although referred to as a slurry and/or brine herein, any input material 102 may be used without departing from the scope of the present disclosure.

Other methods for isolating and/or purifying a species from a feedstock containing the species may include the use of various solvents and processes that require stepwise extraction methods. For example, a first solvent may be employed to remove iron, while a second solvent may be employed to remove silica. Further, other methods for impurity removal may also be employed within the scope of the present disclosure. The shortcomings of related approaches are, for example, moving a stream of feedstock particles through a physical chamber that is capable of various process conditions. The present disclosure, in an aspect, enables a continuous extraction and/or purification of one or more desired output materials 112.

One of the weaknesses that other approaches have displayed is the loading of fresh material and the unloading of spent material. In an aspect of the present disclosure, a slurry and/or brine of feedstock with particles to be separated, purified, and/or isolated is created using various solvents that allow the particles to avoid becoming interlocked when subjected to the temperatures and pressures employed for the separation and/or extraction.

Solvents may include fluids and/or liquids that have the ability to reach various conditions used in processes 100 and/or 200. Examples of such solvents that may be used in aspects of the present disclosure comprise calcium oxide, sulfuric acid, sodium hypochlorite, peroxides, chlorine, and/or other acids or alkaline materials. The present disclosure envisions that any solvent system, individual or multiple constituent, showing a solvency towards alkali metals/alkaline earth metals may be utilized without departing from the scope of the present disclosure. Further, such solvents may be used in conjunction with other solvents, gases, and/or fluids such that a controlled permeation process with a desired efficacy for solubilizing the desired target species in an aspect of the present disclosure.

Further, solvents may be used in combination, and selected and/or combined at various ratios to enable the slurry/brine movement of the particles and the extraction and/or purification of the targeted species, which may be a desired species and/or a targeted impurity, through process 100. The particle size (of either the targeted species or the targeted impurity), the temperature, pressure, and interactions created between the brine and the solvent can be controlled within an aspect of the present disclosure to increase the efficiency of extraction. Further, shear, shear rate, and different shear mechanisms (e.g., mechanical agitation, ultrasonic vibrations, etc.) may be employed to precipitate impurities from the brine and/or purify the targeted species in the brine. One or more solvents may also be employed in aspects of the present disclosure in combination with various pressures, temperatures, and various concentrations of solvents to move the slurry as well as to produce the desired output material 112.

The fluidization process 104 may begin the conversion of the input material 102 into separable species and/or other output products 112. Further, the fluidization process 104 may aid in the filtration of contaminants and separation that may occur later in the process 100.

In an aspect of the present disclosure, the input material 102 may also require some sort of additional material to aid in the fluidization process 104, extraction process 106, or in other processes used in the overall process 100. As such, in the fluidization process 104, other materials, such as liquification enrichments or other additional materials, may be employed to make the remainder of the process 100 more efficient for the input material 102 being used.

The extraction process 106 may convert the raw material particles and/or other by-products that are present in the liquefied input material 102 into species and/or other output products 112. The extraction process 106 may be performed by various methods, e.g., oxidation, bacterial fluidization and/or acid digestion. Fluidization of the input material 102 may extract some certain species, such as lithium hydroxide, directly, which may then be separated from process 100 and/or 200 at this point in the process.

By controlling the pressure, environment, temperature, input material, particle size of the output material 112, and/or the types of liquification/fluidization/chemical extraction of the input material 102, the present disclosure may accept a large range of input material 102 and still produce a desired output material 112 in a cost-effective and efficient manner.

In the separation process 108, the gaseous products of extraction process 106 may be removed, and the species and/or metal output products of extraction process 106 may be separated from each other. As these products are separated, each product may be refined, purified, or separated to increase the percentage of species in the separated portion. The present disclosure encompasses at least one, and perhaps several, output slurries and/or gas flows from the separation process 108, which may be recombined or may be processed separately depending on the desired output material 112.

The separated material is then placed in a concentration process 110. The concentration process 110 provides further separation of desired output materials 112 from the one or more products, and may further refine and or concentrate the products into various output materials 112 and/or byproducts.

In an aspect of the present disclosure, a process is employed to remove one or more impurities from liquid brines. The process may be undertaken by introducing the brine into a common agitated reactor, where various solvents, oxidizers, and/or other chemicals are added in determined ratios and/or quantities to remove determined impurities. The impurities may be removed through precipitation by introducing oxidizing agents to the brine. The oxidization agents may be determined based on an analysis of the brine, such that the amount, type, and process parameters and/or characteristics are determined for a given impurity present in the brine.

The capacity of such a system and/or process is a measure of the amount of impurities that can be removed from the liquid stream before the material is removed via a common solid-liquid separation unit operation. Such solid-liquid separations could include a series of thickeners, clarifiers, filters and/or centrifuges. The capacity, as physically measured by the addition ratios of the material, the particle size of the material or liquid or gas droplet sizes of the material added, the shear rate of the agitated reactor and the residence time of exposure of the liquid stream to the material and the process conditions is dependent upon the concentration and type of species being removed from the brine and/or liquid stream of the brine.

The impurity removal capacity may also dependent upon the details of the process used to form the material. In an aspect of the present disclosure, the process may be controlled by varying the temperature, concentration and exposure time of the substrate material (e.g., brine, feedstock, input material 102, etc.). The mixing shear rate profile used during the production of the material in the common agitator vessel (this process is also referred to as a “wash loading” process) may also affect the output material 112 components and/or purity.

As such, in an aspect of the present disclosure, the added oxidizer material(s) may or may not be heat treated during the process, e.g., prior to or after the loading of the oxidizer material to the brine. Further, pH cycling may also be employed in an aspect of the disclosure to aid in the precipitation of one or more impurities from the brine.

The added oxidizing and/or precipitation-inducing material can be in the form of a gas, slurry, liquid, loose bed of particles, a solid porous structure, a fiber, a block, an agglomerate bound so that the agglomerate formula, form and shape does not interfere with the particle functionality.

The above description with respect to FIG. 1 is an overview of the extraction process 100. Many variations are possible within this general framework of the process 100. In aspects of the present disclosure, reference is made to the process 100, and which potential portion of the process 100 such variations may occur in. However, the present disclosure is not limited to such portions as discussed herein.

In an aspect of the present disclosure, a desired output material 112 is a material with an elevated concentration of a specific species of lithium. Although a high concentration of such a species may be produced from particular input materials 102, the present disclosure discusses, in an aspect, how to increase or elevate the concentration ratios within an output material 112 of a desired species, or any other desired species or by-product, from an input material 102.

For example, and not by way of limitation, in an aspect of the present disclosure a brine and/or input material 102 may only contain 2 wt % of lithium species, which may not be a “high concentration” in absolute terms. However, the process described in an aspect of the present disclosure may increase the concentration ratio of lithium species from 200 ppm to 20000 ppm, which increases the concentration ratio of the brine by a factor of 100.

In another aspect of the present disclosure, a process may be employed to alter the lithium (and/or other desired output material) species to impurities ratio present in the output material 112. For example, a process in accordance with an aspect of the present disclosure may not increase the overall concentration of lithium, but may reduce the impurities such that the lithium concentration may be larger in the overall picture. For example, an additive in accordance with an aspect of the present disclosure may be mixed with a brine having 200 ppm of lithium and 2000 ppm of silicon dioxide (SiO2), which is a ratio of 0.1, and convert that input material 102 to an output material 112 having 200 ppm of lithium and only 20 ppm of SiO2, which is a ratio of 10 (or a concentration ratio of 100).

Depending on the particular input material 102 being employed, variations on the process 100 may be used to produce the output material 112 having the desired concentration of a desired species or the removal of a specified impurity.

For example, and not by way of limitation, a particular input material 102 may require additives to provide the process 100 with a feedstock that can produce the desired output material 112, in this instance, lithium chloride (LiCl). Lithium hydroxide (LiOH) may also be a desired output, and may be produced using the processes 100 and/or 200 described herein, depending on the order of processing steps employed. Further, depending on the type and/or time spent in the extraction process 106, separation process 108, and concentration process 110, the amount of additives may be increased or decreased. The present disclosure manages the entire process 100, including the input material 102, to produce the desired output material 112 more efficiently for a given input material 102.

Some of the difficulties in the process 100 when used to produce lithium chloride, lithium hydroxide, and/or any other lithium species, are that the process 100 may be designed for a single, homogeneous input material 102, e.g. a specific type of raw material from a certain mine. Even when a single input material 102 is used, the extraction process 106 may not be well controlled, and as such it is difficult to produce a consistent lithium species output material 112 having consistent chemical properties.

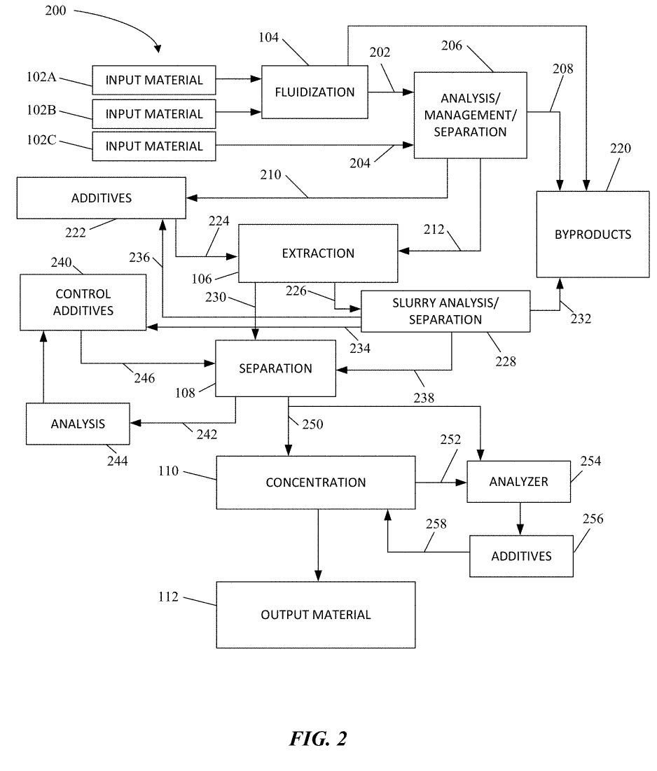

FIG. 2 illustrates a process flow in an aspect of the present disclosure.

In an aspect of the present disclosure, each of the components flowing from one portion of process 200 to another are monitored. This monitoring allows the process 200 to be improved or tailored to a particular input material 102, such that the fluidization process 104, extraction process 106, separation process 108, and concentration process 110 can be altered, or additional materials can be added to the overall process 200, to produce a desired output material 112, and/or a desired output material 112 having specific qualities or characteristics.

By controlling each of the processes 104-110 in the process 200 for each individual input material 102, as well as each “batch” of the input material 102 that is placed into the process 200, a more consistent output material 112 may be obtained. Further, as different input materials 102 and different desired output materials 112 are entered into or extracted from the process 200, the process 200 controls and monitoring allow for a wider range of materials to be used in, and produced by, the process 200. Further, a single line of equipment may be used to perform process 200 and still accept various input materials 102 and produce various output materials 112.

### Fluidization Process

As shown in FIG. 2, different types of input materials 102, shown as input materials 102A, 102B, 102C, may be used as feedstocks for the process 200. Further, depending on the desired process 200, one or more of the input materials 102A, 102B, and/or 102C may be pre-processed prior to the process 200, and more than one of the input materials 102A, 102B, and/or 102C may be used in any combination as inputs to the process 200. The present disclosure is not limited to three input materials 102A, 102B, and 102C; any number of input materials may be used without departing from the scope of the present disclosure.

Depending on the composition of the input material, the process flow may use the fluidization process 104 to provide a uniform material 202. Otherwise, the input material 102A, 102B, and/or 102C may flow directly as material 204 (which may also be referred to as a slurry) to an analyzer 206. Fluidization process 104 may use a mechanical homogenization process, a macerator, or other mechanical, electrical, or biological device to provide desired characteristics within the input material 102A-102C. Further, the fluidization process 104 may be used to provide a more uniform feedstock to the extraction process 106.

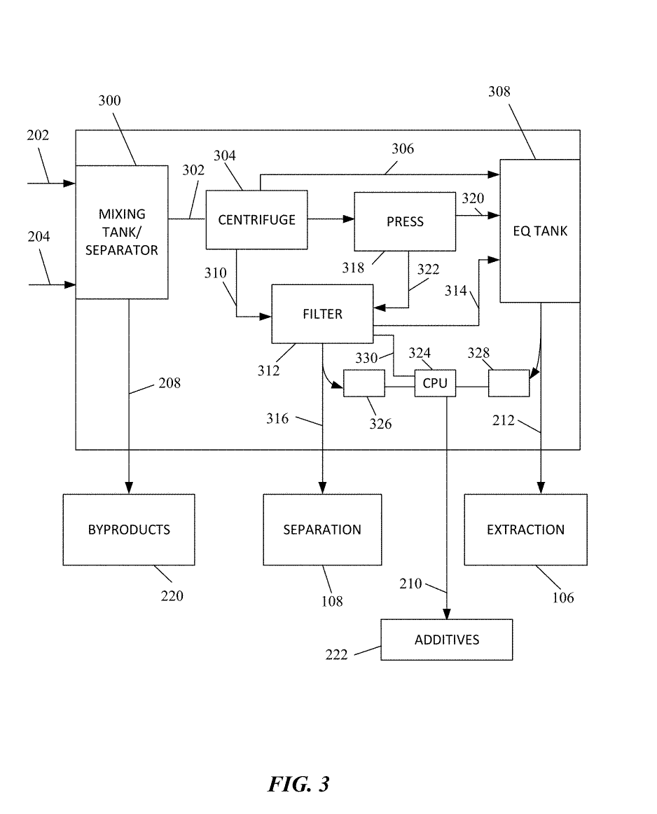

FIG. 3 illustrates an example of an analyzer in accordance with an aspect of the present disclosure.

An example of a mixing tank/separator, also referred to as an analyzer 206, is shown in more detail in FIG. 3 in accordance with an aspect of the present disclosure. The materials 202 and/or 204 may be initially placed in a mixing tank 300. The mixing tank may homogenize the materials 202 and/or 204 if needed into a single mixed material 302. Further, the mixing tank 300 may separate out a flow 208 containing inert materials, such as metals, plastics, and other materials that may not be converted into the output material 112 when subjected to the process 200. The flow 208 is sent from the analyzer 206 to a byproducts container 220 for further separation and/or disposal.

From the mixing tank 300, mixed material 302 is placed in a centrifuge 304 or other device that separates the mixed material 302 by density, weight, size, or other methods of separation. Some outputs 306, which may contain certain species at this point in process 200, may be directed to an equalization tank 308, as the output 306 may approximate or already be a desired output material of the analyzer 206. Some outputs 310 may still be liquids mixed with some denser or larger material, and may be passed through a filter 312 to separate the liquid from the denser or larger material such that the denser or larger materials form an output 314 that can also be sent to the equalization tank 308. The equalization tank, as well as the rest of the analyzer 206, may be environmentally controlled in temperature, pressure, humidity, or other factors, to increase the ability of the process 200 to extract the necessary species and other products from mixed material 302. The liquid 316 from the output 310 may also be a desired output of the analyzer 206. The material that forms the output 314 may be sent to separation process 108.

Still other material 316 from the centrifuge 304 may need to be compressed or otherwise processed in a press 318 to remove additional solids 320 that can be converted into the desired output material 112. After the liquid 316 is pressed, the output 322 from the press 318 may also be filtered in the filter 312.

The filter 312, which may be a particle filter, membrane filter, or electromagnetic filter, allows the process 200, and the analyzer 206, to accept multiple and varied feedstocks (materials 202 and 204) into the process 200. By controlling the size of particles that are separated by the filter 312 contaminants to the process 200 may be strained out, and various different liquids may be separated, that contain different byproducts that may be usable within the process 200. Further, the byproducts can be directed to different places within the process 200, or may be transferred to different machines and/or different processes, because of the variability allowed through the filter 312.

For example, and not by way of limitation, the filter 312 may be used to filter different sizes of species particles for use in different products. Some small diameter species, e.g., lithium hydroxide, may be used in one process to make an output material 112. Other species, e.g., lithium sulfate, may be separated using the filter 312 for use in other output materials 112. Further, the filter 312 may be electrically and/or mechanically changed within the process 200 to perform both of these separations, as well as additional separations, as desired.

The equalization tank 308 may also be used to provide a proper balance of solids to liquids to the extraction process 106. For example, depending on the input material 102 and extraction process 106, a preferred percentage of solids, may produce the desired output material 112 more efficiently than other percentages of solids when placed in the extraction process 106.

In an aspect of the present disclosure, the analyzer 206 may include a processor 324, which may be coupled to sampler 326 and/or sampler 328. Sampler 326 monitors and/or samples the liquid 316, to determine if the liquid 316 is ready for separation process 108. Further, the sampler 326, which provides information to the processor 324, may aid in controlling the separation process 108, by changing parameters of the separation process 108. For example, and not by way of limitation, the sampler 326 may determine that the liquid 316 has a concentration of lithium species of 1 percent. The processor 324 may then vary the time, heat, pressure, and other factors used in the separation process 108 to produce a greater or lesser concentration of lithium species, and/or desired output, from the separation process 108.

Further, the processor 324 may accept data or input information from the sampler 328, which monitors the characteristics of the equalization tank 308. In a similar fashion, the processor 324 may alter the parameters of the extraction process 106 based on the analysis provided by the sampler 328. The processor 324 may also receive input signals from other parts of the process 200, such as analysis of the extraction process 106 output, separation process 108, etc., and provide output signals 210 to other parts of the process 200, such as signals to add materials to process 200 from an additive bank 222, increase or decrease fluidization time, etc., to make the process 200 more efficient for the flows of materials 202 and 204. The processor 324 may also send signals 330 to control the filter 312, or to control other portions of the analyzer 206, within the scope of the present disclosure.

As shown in FIG. 3, the analyzer 206 separates the flows of material 202 and/or 204 into various components. From the mixing tank 300, byproducts and/or inert materials may be separated from the overall feedstock. The centrifuge 304, press 318, and filter 312 remove solids from liquids in the feedstock. Liquids may be passed to the separation process 108, and solids may be sent to the equalization tank 308. Additives may be added to the equalization tank 308 to begin the breakdown of the solid materials if desired. Further, the samplers 326 and/or 328 may be used to sample the liquids and solids, to evaluate the materials being passed to subsequent portions of the process 200. Additives, such as nitrogen, phosphorus, potassium, or other micronutrients may be added to the liquid 316 flow, or the solid flow 212, to increase the efficiency of the overall process 200 and/or to produce a desired output material 112.

Returning to FIG. 2, flow 208 is passed to the byproducts container 220 from the analyzer 206. As discussed above, the byproducts container 220 may receive plastics, metals, or other products that may deleteriously affect the process 200. Output signals 210 based on the analyzer 206 may be sent to the additive bank 222, such that selected additives and amounts may be added to the extraction process 106. The solid flow 212, from the equalization tank 308, may be added to the extraction process 106.

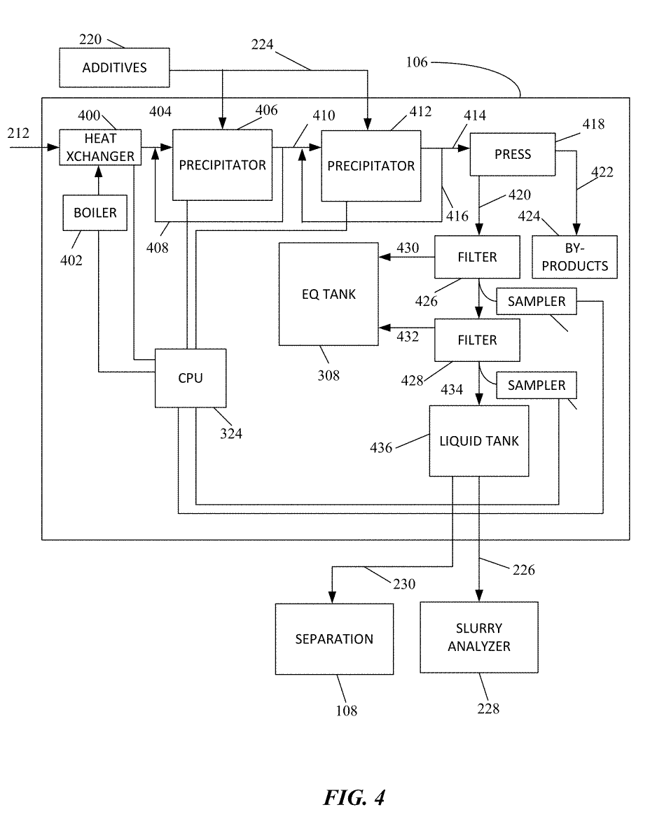

FIG. 4 illustrates the fluidization process in accordance with an aspect of the present disclosure.

In an aspect of the present disclosure, the extraction process 106 is described in further detail in FIG. 4. Although an extraction process 106 that is biological can be used in the present disclosure, in an aspect of the present disclosure chemical extraction may be performed. The solid flow 212 may initially need to be placed in a heat exchanger 400, which may receive heat from an electric or other type of boiler 402. Once the output has received sufficient heat, the material 404 is placed in a precipitator 406, which may be a digester, fluidizer, hydrolysis tank, or other holding tank as desired. The precipitator 406 may have a recirculating output 408 that is fed to the input of the precipitator 406.

The precipitator 406 may precipitate components of the material 410 into species present in the raw material. Because the material 404 may not have included a desired chemical composition, the processor 324 may have sent signals to the additive bank 222, or to an operator, to add specific amounts 224 of certain additives, certain types of solvents, oxidizers, or other additives from the additive bank 222 to the precipitator 406.

If desired, the material 410 from the precipitator 406 may be placed into one or more additional precipitators 412. Having multiple digesters allows the process 200 to employ different types of bacteria, produce different types of species, or obtain additional material 414 to be used in the output material 112 production. The precipitator 412 may also have a recirculating output 416 that is fed to the input of the precipitator 412. As with the precipitator 406, because the material 410 may not have included a desired chemical composition, the processor 324 may have sent signals to the additive bank 222, or to an operator, to add specific amounts 224 of certain additives, different types of bacteria, etc., from the additive bank 222 to the precipitator 412, or to change the operational characteristics of the precipitator 412.

Each of the precipitators 406 and 412 may use different types of processing to react with the brine and/or other impurities present in the material 102. Each of the precipitators may use batch flow processing, sequential batch processing, continuous processing, or plug flow processing.

Further, each of the precipitators 406 and 412 may use different types of oxidizers and/or solvents, or may use different types of fluidization to produce different slurries of the input material 102. The material 414 that is output from the precipitator 412 may be sent to a press 418, where liquids 420 and solids 422 are separated. The solids 422, which may be an impurity, may be used as by-product 424, and/or may be used elsewhere in the process 200, depending on the impurity solids 422 produced at this point of the process 200.

The liquids 420 may then need to be filtered through filter 426 and/or filter 428. The filters 426 and 428 may provide different levels of filtration for the liquids 420. For example, and not by way of limitation, the filter 426 may be an ultrafiltration system, while the filter 428 may be a nanofiltration system. Solids 430 and 432, which may be other impurities that have precipitated out of the liquids 420 may be sent to the equalization tank 308, as desired.

The liquids 434, after filtering, may be sent to a tank 436 for holding the liquids 434, or may be sent to slurry analyzer 228, or may be sent directly to separation process 108.

The liquids 434, as well as the liquid 420 and any other filtered liquid in the extraction process 106, may contain the desired species and/or other desired solids and/or liquids. The filters 426 and 428, as well as the press 418, provide various opportunities to separate the solids (e.g., impurities) in material 414 from the liquids 420 and 434 within the extraction process 106. Each of these liquids 420 and 434 (and any other liquid containing the desired species and/or desired other output material 112) may be separated, either with filters 426 and/or 428, or other separation techniques, to isolate each of the desired species as desired.

To control the presence/absence/concentration, the additive bank 222 may be employed to provide the precipitators 406 and/or 412 with ingredients that adjust the solvent concentrations and/or species output. The samplers 440 and 442, which may be coupled to the processor 324 or another processor within the extraction process 106, may assist in controlling the species concentrations in the liquids 434 and 420, and thus controlling the species and/or other output material 112 concentrations in the outputs 226 and 230 from the extraction process 106.

The solids separated from the precipitators 406 and/or 412 may still contain useable material that can be used to produce other species and/or other desired output materials 112. Such solids may be processed either within the process 200, or in another process.

In an aspect of the present disclosure, processor 324, or another processor in within the extraction process 106, may determine performance metrics for the process 200. Such metrics may include capacity, precipitation capacity, and removal efficiency. A capacity of a system employing process 200 may be determined as the mass of material removed divided by the volume and/or mass of the material added. A removal efficiency of a system employing process 200 may be determined as the mass of impurities removed divided by total mass of brine flow, which may be reported in units of gram/gram. A material performance may be dependent upon the conditions of the system employing process 200, which may be dependent upon particle size, temperature, flow rate and pressure drop.

### Lithium Separation and/or Extraction

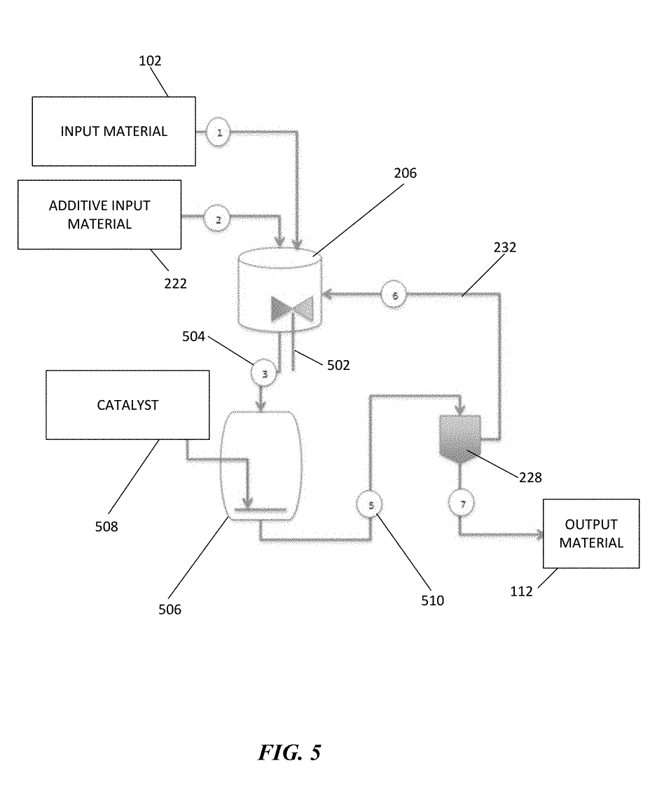

FIG. 5 illustrates a system in accordance with an aspect of the present disclosure.

System 500 shows input material 102 and, optionally, additive input material 222 being input into analyzer 206. A mechanical/electrical impeller 502 mixes the slurry 504 (the combination of input material 102 and additive input material 222) in analyzer 206. At this point, the slurry 502 is more easily moved, as additive input material 222, which may comprise a solvent, is being used as a carrier liquid in this portion of the system 500.

As slurry 504 is moved to reactor 506, some of the carrier liquid portion of slurry 504 may be removed from reactor 506, as having a large ratio of carrier liquid to input material 102 may hinder the physical loading and unloading problems for slurry 504 and may also hinder the extraction effectiveness of the system 500. For example, and not by way of limitation, calcium oxide (CaO), also known as “quicklime,” may be used as an additive input material 222 to fluidize the slurry 504 from analyzer 206 to reactor 506. Once the slurry 504 has been moved to reactor 506, the calcium oxide may be removed from reactor 506 and reaction conditions may be initiated to begin extraction of species and/or other outputs from slurry 504. Residual calcium oxide in slurry 504 may be used to assist in the extraction. Other additive input materials 222, such as carbon dioxide gas, other gasses, other solvents, and/or other materials may be used without departing from the scope of the present disclosure.

When in reactor 506, a catalyst 508 may be added to reactor 506. Catalyst 508 may be another solvent, or may be steam, pressure, temperature, or other characteristic that acts upon slurry 504 (and/or additive input material 222) to create a desired reaction within reactor 506. Reactor 506 is configured to produce temperature, pressure, and/or volume constraints on slurry 504 to remove one or more desired species from slurry 504.

If desired, a second catalyst 508, and/or a second set of conditions for reactor 506, may be applied to slurry 504 while slurry 504 is present in reactor 506. Such a second catalyst 508 may extract a second species from slurry 504, and/or may be employed to further extract additional amounts of the species extracted earlier in reactor 506.

In an aspect of the present disclosure, catalyst 508, and/or additive input material 222, may be selected to extract selected species, as well as allowing slurry 504 to change from a fluid slurry that is easily transported to a solid slurry that may be more easily processed. By selecting these materials, also referred to as a “solvent set” herein, an aspect of the present disclosure at least partially overcomes the difficulties of moving slurry 504 through system 500. A solvent set for a given desired output material 112 may transform slurry 504 from a liquid slurry carry capacity state which enables loading of the reactor 506 to a state which enables the extraction of desired output materials, and may also enable and movement of the slurry 504 in a continuous fashion.

As the reaction is completed in reactor 506, slurry 510 may be moved to a separator tank 228, again through the use of solvent set if desired. Slurry 510 may also be flushed from reactor 506 to tank 228 by pressure, additional slurry carrying liquid, or other means. Separator tank 228 may be used to recycle material 232 back to tank 206, or to remove spent solids and/or liquids from system 500, as desired.

The present disclosure produces an “extracted material” or simply “material” which may be in the form of various states of matter and of various concentrations and relative ratios of the species outlined above. In an aspect of the present disclosure, an output is the unique material made up primarily of various species that will be the feedstock for further refining and purification to produce market ready products.

The material is produced in mixing systems applied with high shear versus the more common chemical industry batch tanks, columns, and continuous mixed reactors of various configurations. In an aspect of the present disclosure, shear, e.g., the interaction of the input material 102 and other particles and the liquids and gasses in the reactor 506 environment creates forced dynamic interactions between the input material 102 and one or more solvents due to the temperature, pressure and physical properties, such as particle size and concentration of solvent, etc., of the various constituents present in reactor 506. This environment exposes the surface areas of the solids, the liquid droplets, and/or the gaseous fluid boundaries to each other, which increases the probability of interactions between the solvent(s) and the input material 102. The shear, shear rate, and/or shear mechanism of the present disclosure helps enable the mass transfer (i.e., extraction of desired output materials 112 and/or removal of impurities from input material 102) in conjunction with the temperature and pressure in reactor 506. The shear may be imparted by mechanical means within reactor 506, e.g., via an agitation device and/or by fluid dynamic means, which may adopt one or more physical configurations of piping, pressure chambers, and/or cavities defined by the physical arrangement of pipes and tanks throughout the system.

Further, the interaction between input material 102 and solvents may be increased by “shearing” input material into smaller pieces. In an aspect of the present disclosure, this shear may be accomplished through friction between particles in the fluid stream, friction with the particles hitting some stationary portion of the piping, and/or through mechanical energy additions to the slurry, e.g., agitators, ultrasonics, rotor/stator mixers, pitched blades, etc.

In an aspect of the present disclosure, a brine containing Lithium may also contain impurities of silica, iron and alumina, as well as other impurities from Group II or other metals. In this brine (i.e., input material 102), a system in accordance with an aspect of the present disclosure may adjust the pH of the brine by using a suitable oxide or hydroxide, which may be lime, calcium oxide, or calcium hydroxide. The pH adjustment may be effective in a range between 4.5 and 8.5. Above a pH of 8.5, lithium in the brine may be lost.

The hydroxide may be added to the input material 102 in stoichiometric excess. For example, a stoichiometric ratio between 1.1 and 3.0 may be used in an aspect of the present disclosure. Addition of hydroxide beyond a stoichiometric ratio of 3.0 may become cost prohibitive depending on the remainder of the process 100 and/or 200, and the sale price of the output material 112.

In another aspect of the present disclosure, air may be added to the brine using high shear mixers and air sparging systems. This aids in the oxidation of the iron in the brine, and precipitates the iron from the brine as iron oxide. The introduction of air to the brine may also precipitate silica and alumina as silicon oxide and aluminum oxide from the brine.

As with the hydroxide, in an aspect of the present disclosure the air addition ratio may be dependent upon the temperature of the brine. The air may also be added in stoichiometric excess, for example at an air stoichiometric ratio between 1.1 and 20. The temperature of the brine may be between 120 F. and 200 F. Other combinations of stoichiometric ratio and temperature may be employed within the scope of the present disclosure. Depending on the temperature, pH, and air stoichiometric ratio used in a particular process 100 and/or 200, high shear gas dispersion may also be employed for effective impurity removal. Such high shear gas dispersion may include very high power to volume ratios for the agitator.

In an aspect of the present disclosure, an oxidizer is added to the input material 102 to more effectively enable the oxidation of the iron and the co-precipitation of the impurities of iron, silica and aluminum. For example, and not by way of limitation, addition of sodium hypochlorite in a stoichiometric ratio to the impurity mass between 1.1 and 10 may be used. Further, wide concentrations of sodium hypochlorite, e.g., 10 ppm through 15 wt % (150000 ppm) may be employed without departing from the scope of the present disclosure. Other oxidizers, such as chorine or hydrogen peroxide, may also be used in similar ratios that would be approximately equivalent to the sodium hypochlorite ratio when taking the available chlorine or the active oxygen content of alternative oxidizers into account. The temperature, pressure, and other reactor parameters, as well as other system components, may be altered, added, or deleted based on the oxidizer employed in the process 100 and/or 200.

The oxidizer is added to the input material 102 for a determined amount of time, which may be monitored and/or controlled by processor 324. For example, a reaction time of between 10 and 30 minutes may be employed when sodium hypochlorite is employed as an oxidizer. The design of the reactor may also be changed and/or designed to more effectively cooperate with a given oxidizer. For example, a 2:1 high side wall profile mix tank may be employed to maintain the gas addition under significant liquid head pressure, and to more effectively control changes in liquid, gas, and solid surface area contact time.

As particles precipitate from the brine when the oxidizer is added, the precipitated oxidized species will settle to the lower levels of the reactor. The precipitated particles may be removed from the reactor using an overflow piping arrangement. The removed precipitate may be referred to as an overflow slurry, which may be further settled in a rake type thickener. The underflow thickened slurry is fed to a solid-liquid separation unit operation with the filtrate recycled to the thickener. A portion of the underflow thickener may also be recycled to seed the precipitation and oxidation reactors.

A seeding ratio may be used to control the precipitate removal, and such control may be provided by processor 324. For example, a variable seeding ratio, such as a ratio of 1 to 5 by flow volume, may be employed to control the flow through process 100 and/or 200. The mass density of the seed slurry flow and the feed slurry flow to the reactors may also affect throughput and/or precipitate removal efficiency. The overflow of the thickener may be processed by filtration or a centrifuge as desired, such that the removed impurity product may be processed further.

Lithium species, as well as other species such as sodium and potassium, may remain in solution after process 100 and/or 200 are completed. This solution (output material 112, or brine) may also contain part per million level dissolved impurities, which may be at or approaching their solubility limit. Silica, iron, aluminum, Group II elements, and metals in the output material 112 may have been removed such that the output material 112 can be further processed to isolate, concentrate, and/or otherwise extract the desired dissolved constituents.

The process 200, at least through the samplers 326, 328, 440, and 442, may have automated (via the processor 324) or manual monitoring and adjustment of the process materials to ensure the consistent production of the output material 112 having the desired material properties. The process 200 samples materials throughout to measure concentrations of additives and/or output materials and then calculates the supplemental material to add to or dilute the process material in order to achieve a desired recipe for consistent material properties in the output material 112. Some materials that are created, or are byproducts of, the process 200, may be inhibitory to the digestion process of the digesters 406 and/or 412. The process 200 recaptures these species and/or other materials as a by-product of the process 200, which also aids in the efficiency of the process 200 overall.

In an aspect of the present disclosure, the process 200 employs high shear to enable the various small particle-larger particles attractions in the reaction to be broken down, which enables the reaction to continue. In an aspect of the present disclosure, process 200 may use a controlled temperature, pressure, and/or amount of additive to allow the solubility of the various constituents to drive the reaction rate. The combination of high shear and controlled temperature may be different for each combination of the use of the alkali metals or the alkaline earth metals in the process 200.

In an aspect of the present disclosure, process 100 and/or 200 moves the slurry through a recirculation loop. The related art issues with limited solid-to-solid reaction surface area are eased by using two different types of equipment (e.g., digesters 406 and 412) to move the slurry in combination with the recirculation loop. The heated slurry with small particle sizes enables sufficient interactive reaction sites to extract the desired species. Further, the controlled temperature allows the dissolution and miscible solubility of the various species to allow the needed interaction(s) for reaction. The solids are added at the atmospheric high shear mixer vessel. The slurry is heated and pressurized in a controlled manner in the pressure vessel in series with the atmospheric high shear mixing vessel. The output material 112 product is taken off the recirculation stream and the recycle ratio is a component of the controlled temperature mechanism of the system.

### Extraction Example

The input material 102 may be sheared into smaller pieces with a grinder, chopper, or other mechanical device to allow the input material to have a larger surface area for the solvent to contact the input material 102.

The sheared input material 102 may then be mixed with a solvent, e.g., sulfuric acid, and/or other acid solutions, sodium hypochlorite, peroxides, chlorine, bleach, etc., such that the mixture of input material 102 and solvent (now called a “slurry”) may move through the system and be exposed to desired portions of process 100 and/or 200. The ratio of input material 102 to solvent may be determined by weight percent (wt %), efficiency of the solvent used, reactor 506 conditions, or other parameters, including the ability of the slurry to move through the system and process 100 and/or 200.

The size of the solids (e.g., particle size) in input material 102 may also be controlled as a parameter for consideration in process 100 and/or 200. The particle size of input material 102 may assist in the ability of a particular solvent to extract a desired output material 112, in combination with temperature, pressure, and/or specific constituents present in reactor 506 during extraction. The surface area to solvent ratio, and the ability of solvents to interact with input material, may provide additional efficiencies within an aspect of the present disclosure.

For example, a 30 wt % to 70 wt % slurried input material 102 may operate between 0 psig and 15 psig in a temperature range of 30 degrees F. to 800 degrees F. in the system. The particle size of the input material 102, in such an example, may have the solid portion of the slurry mass be filtered between a 325 mesh (44 microns) and 10 mesh (2000 microns or 2 mm). Rates of extraction of such a slurry, and the yield of extraction, can be tuned to extract specific constituents present in the slurry using different extraction solvent make ups. Processor 512 may control the temperature and pressure, while monitoring the amount of output material 112 produced, to increase the efficiency of the process 100 and/or 200.

In reactor 506, extraction conditions, e.g., temperature, pressure, wt %, additional solvents, and/or other parameters are arranged to allow the solvent(s) to attain an efficient removal of the desired products from the slurry of input material 102. The reaction can be controlled to increase the amount of a desired species removed from the input material 102 feedstock, and the solute (the desired species) is then removed from the liquid either through filtration or other methods (centrifuge, mass separation, magnetic/electric fields, etc.). The output material 112 may be selected by particle size, and the reactor 506 conditions may be selected to determine the particle size(s) desired as output materials 112.

In reactor 506, extraction conditions, e.g., temperature, pressure, wt %, additional solvents, and/or other parameters are arranged to allow the solvent(s) to attain a supercritical state. In other words, the solvent(s) in supercritical states begin to efficiently (or more efficiently) remove the desired output material 112 from the input material 102 solids. The reaction can be controlled to increase the amount of a desired species removed from the input material 102 feedstock, and the solute (the desired species) is then removed from the liquid either through filtration or other methods (centrifuge, mass separation, magnetic/electric fields, etc.). The output material 112 may be selected by particle size, and the reactor 506 conditions may be selected to determine the particle size(s) desired as output materials 112.

Once the output material 112 is separated from the slurry, the slurry can then be separated into solids (which may act as another input material 102), gases (which may be another output material 112), and fluids (which may be the remaining solvent). These can either be recycled alone or in combination to be processed again through process 100 and/or 200, have the fluids removed for re-use in the system on other input materials 102, and/or the solids can be processed using another solvent to remove other output materials 112 from the solids (which are another input material 102 at this point). The separation of solids, fluids, and/or gases may be performed at any time during process 100 and/or 200 without departing from the scope of the present disclosure.

Each of the solids, fluids, and gasses remaining in the slurry after output material 112 may act as another input material 102. Further, each of the remaining solids, fluids, and gasses remaining in the slurry after output material 112 may be recycled as a solvent, processed as waste, or used elsewhere in process 100 and/or 200 without departing from the scope of the present disclosure.

If the input material 102 is a different raw material, or has a different chemical makeup than the first-used input material 102, then the reactor 506 parameters may have to change to extract the desired species from that input material 102. Further, if a different output material, e.g., a different species, is to be extracted in reactor 506, different solvents, reactor 506 conditions, etc., may be employed to extract the different desired output material 112.

In the present example, it can be seen that processor 512 may control one or more aspects of process 100 and/or 200. As process 100 and/or 200 is being performed, processor 512 may monitor reaction time, temperature, pressure, amount of solute obtained, solute percentages, etc., and may change these parameters during one or more portions of process 100 and/or 200 to increase efficiency. Further, processor 512 may store the parameters of a given process 100 and/or 200 for a given input material 102, and such parameters may be adjusted, stored, saved in memory, etc., until the process parameters create a higher efficiency process for extraction within the system. Further, the particle size of output material 102 may be monitored and/or verified by processor 512 to determine the extraction efficiency of process 100 and/or 200.

As can be seen with the above example, there can be more than one reactor 506 within the system to allow for the extraction of different solutes from a given input material 102. Further, multiple solutes may be extracted in a single reactor 506, depending on the solvent, reactor 506 conditions, etc. Any combination of multiple solvents, multiple solutes, different input materials 102, multiple reactors 506, etc., are possible without departing from the scope of the present disclosure.

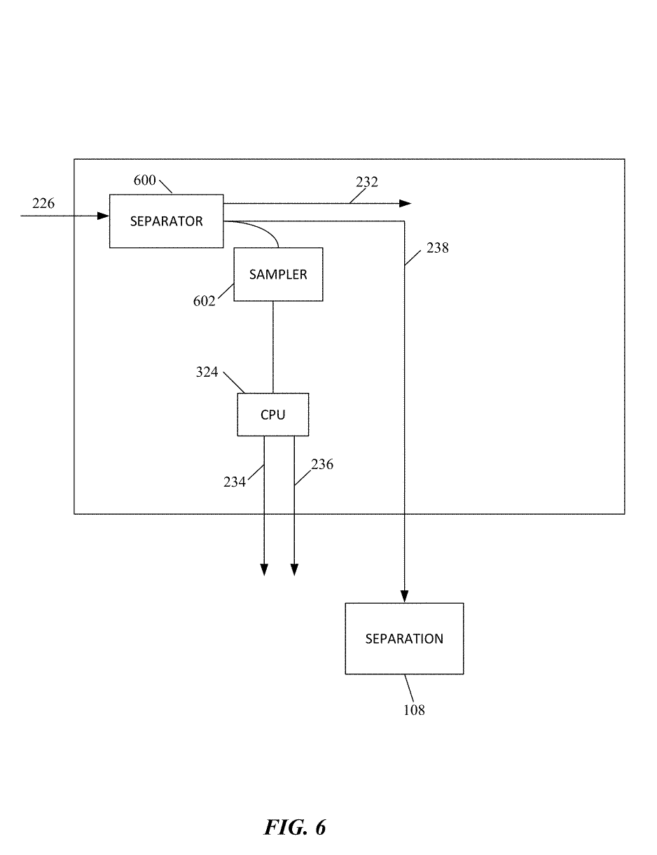

FIG. 6 illustrates a slurry analyzer 228 in accordance with an aspect of the present disclosure. Slurry analyzer 228 accepts output 226 from the precipitator 406, and separates the incoming material in separator 600. Separator 600 may, for example, separate a specific species from the acids and send that species as a byproduct via 232. Other separations may be done by separator to separate individual species from the output 226.

To separate each species, or one output of the slurry analyzer 228 from another, a sampler 602 samples the output stream 238. This may be analyzed electronically through the processor 324, or manually, as desired. The processor 324 may send signals 234 and/or 236 to control the additive bank 222, or the separation control additives 240, to control other parts of the process 200. These signals may be administered manually by an operator if desired.

Referring again to FIG. 2, the separation process 108 may also be analyzed, either electronically or manually, to determine the concentration of species in the separated product 242. The analysis 244 may be similar to those analyses described with respect to FIGS. 3-5. The analysis 244 may also provide inputs to the separated control additives 240 to provide inputs 246 that change the separation process 108, such as pressure, temperature, steam or other vapor use, etc.

The output stream 238 is also sent to separation process 108, which has a broth 250 as an output used during the concentration process 110. The broth 250 prior to separation, or a separation stream 252 that may be analyzed during or after separation, may be sent to separation analyzer 254. The separation analyzer 254 examines the separation stream 252 and/or broth 250, and determines, either chemically, visually, or through other analyses, to determine whether or not the concentration process 110 is producing the desired output material 112. If not, the separation analyzer 254 may, either independently or through the processor 324, control separation additives 256 to add materials 258 to the concentration process 110, in order to produce the desired output material 112.

The separation analyzer 254 may use a microscope, camera, spectrophotometer, or other device, and software or other comparison tools, to compare a sample of the broth 250 and/or the separation stream 252 to a known sample of material. Through visual, chemical, or structural comparison of the broth 250 and/or the separation stream 252, the separation analyzer may alter the concentration process 110, or other portions of the process 200, to more closely match the broth 250 and/or the separation stream 252 to the known material. This comparison may be done in real-time to control the process 200 during operations. For example, and not by way of limitation, lithium hydroxide concentration may be measured by sampling the broth 250 with a chemical analyzer. Recognition software or other recognition methods may identify a concentration of lithium chloride, lithium hydroxide, or other lithium species present in the broth 250.

Further, the separation analyzer may also determine other characteristics of the broth 250 and/or the separation stream 252, such as the percentage of weight of the cells in the material, percentages of other cells in the material, etc. This information can then be stored for later analysis, or placed in records for each batch of materials being produced, or may be used as a trigger to stop the production process when a desired species concentration or other material properties are reached. The separation analyzer may also use different wavelengths or different sensors to determine the percentage of different species to allow for additional analysis of the broth 250 and/or the separation stream 252.

The output of the concentration process 110 is the desired output material 112. The output material 112 may also be analyzed to determine if other characteristics of the process 200 may be changed to increase the efficiency of producing the desired output material 112. Further, the analysis of the input material 102, the automated and/or manual changes made to the process 200, and the chemical and structural properties of the output material 112, may all be stored and/or recorded such that future processes 200 may be tailored using the changes made to the process 200 for a particular batch of input material 102.

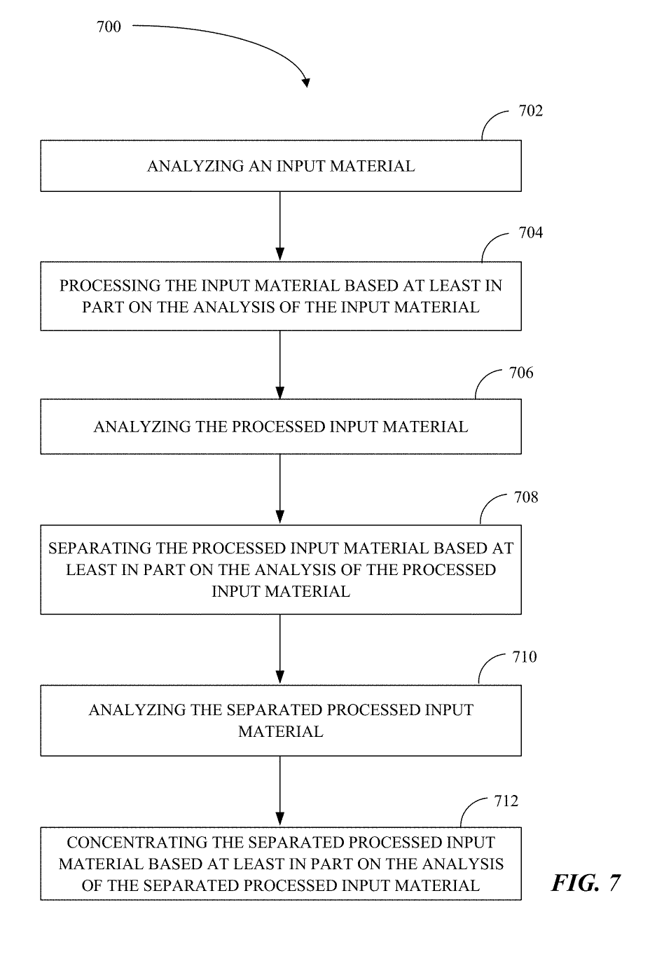

FIG. 7 illustrates a process flow diagram illustrating a method 700 for producing oils in accordance with an aspect of the present disclosure. In block 702, an input material is analyzed as shown in FIGS. 2 and 3. In block 704, the input material is processed based at least in part on the analysis of the input material, as shown in FIGS. 2, 3, and 4. In block 706, the processed input material is analyzed as shown in FIGS. 2 and 4. In block 708, the processed input material is separated based at least in part on the analysis of the processed input material as shown in FIG. 2. In block 710, the separated processed input material is analyzed as shown in FIG. 2. In block 712, the separated processed input material is separated based at least in part on the analysis of the separated processed input material as shown in FIG. 2.

For a firmware and/or software implementation of the present disclosure, such as with respect to the processor 324, the methodologies described may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Although the present disclosure and its advantages have been described in detail, it should be understood that various changes, substitutions and alterations can be made herein without departing from the technology of the disclosure as defined by the appended claims. For example, relational terms, such as “above” and “below” and/or “inside” and “outside” are used with respect to a specific device. Of course, if the device is inverted, above becomes below, and vice versa. Additionally, if oriented sideways, above and below may refer to sides of a device. Further, reference to “first” or “second” instances of a feature, element, or device does not indicate that one device comes before or after the other listed device. Reference to first and/or second devices merely serves to distinguish one device that may be similar or similarly referenced with respect to another device.

Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The description of the disclosure is provided to enable any person skilled in the art to make or use the disclosure. Various modifications to the disclosure will be readily apparent to those reasonably skilled in the art, and the generic principles defined herein may be applied to other variations without departing from the spirit or scope of the disclosure. Thus, the present disclosure is not intended to be limited to the examples and designs described herein but is to be accorded the widest scope consistent with the principles and novel features disclosed herein. Accordingly, the disclosure is not to be limited by the examples presented herein, but is envisioned as encompassing the scope described in the appended claims and the full range of equivalents of the appended claims.

What is claimed is:

1. A method for extracting a material, comprising:
analyzing an input material;
processing the input material based at least in part on the analysis of the input material;
analyzing the processed input material;
separating the processed input material based at least in part on the analysis of the processed input material;
analyzing the separated processed input material; and
processing the analyzed separated processed input material based at least in part on the analysis of the separated processed input material.

2. The method of claim 1, wherein processing the input material comprises shearing the input material.

3. The method of claim 1, wherein processing the input material comprises controlling at least one of a temperature, a pressure, a pH, and a shear rate that the input material is exposed to during processing of the input material.

4. The method of claim 3, wherein analyzing the processed input material is performed in parallel with processing the input material.

5. The method of claim 4, wherein separating the processed input material comprises filtering the processed input material.

6. The method of claim 5, wherein analyzing the separated processed input material comprises changing the processing of the input material.

7. The method of claim 6, further comprising monitoring at least one characteristic of the processed separated processed input material.

8. The method of claim 7, wherein the at least one characteristic is selected from a group consisting of reaction time, temperature, pressure, amount of solute, and solute percentage.

9. The method of claim 7, further comprising storing at least one process parameter for the analyzed input material.

10. The method of claim 9, further comprising adjusting the stored at least one process parameter based at least in part on the at least one characteristic.

11. An apparatus for extracting a material, comprising:
an analyzer for analyzing an input material;
a container for processing the input material based at least in part on the analysis of the input material;
a separator for separating the processed input material based at least in part on an analysis of the processed input material; and
an apparatus for measuring a presence of the material in the separated processed input material.

12. The apparatus of claim 11, further comprising a device for shearing the input material based at least in part on the analysis of the input material.

13. The apparatus of claim 11, further comprising a controller, coupled to the container, for controlling at least one operating condition of the container, the at least one operating condition consisting of a temperature, a pressure, a pH, and a shear rate of the input material in the container.

14. The apparatus of claim 13, wherein the controller modifies the at least one operating condition while the input material is in the container based at least in part on the analysis of the input material.

15. The apparatus of claim 13, wherein the controller modifies the at least one operating condition while the input material is in the container based at least in part on the presence of the material in the separated processed input material.

16. The apparatus of claim 15, further comprising a device for monitoring at least one characteristic of the processed separated processed input material.

17. The apparatus of claim 6, wherein the at least one characteristic is selected from a group consisting of reaction time, temperature, pressure, amount of solute, and solute percentage.

18. The apparatus of claim 17, further comprising a memory for storing at least one process parameter for the analyzed input material.
